(19) United States
(12) Patent Application Publication
(10) Pub. No.: US 2019/0232094 A1
(43) Pub. Date: Aug. 1, 2019

(54) Method and Device for Fire Protection by a Hybrid Composition of Mist and Inert Gas

(71) Applicant: Nanomist Fire Safety, LLC, Macon, GA (US)

(72) Inventors: Adiga C. Kayyani, Macon, GA (US); Rajani Adiga, Macon, GA (US); Herbert W. Graves, Macon, GA (US)

(73) Assignee: Nanomist Fire Safety, LLC, Macon, GA (US)

(21) Appl. No.: 16/239,486

(22) Filed: Jan. 3, 2019

Related U.S. Application Data
(60) Provisional application No. 62/613,682, filed on Jan. 4, 2018.

(51) Int. Cl. A62C 5/00

(52) U.S. Cl. CPC A62C 5/008

(57) ABSTRACT

A device, composition, and a process for a hybrid blend of inert gas and mist produced for fire protection by local or total flooding. The method mixes ultrafine water mist, preferably less than 20 microns diameter produced by atomization and an inert gas such as nitrogen. A homogeneous hybrid composition discharges from a swirling flow mixer-injector device. The hybrid composition extinguishes a fire source in reduced time by simultaneous and synergistic cooling with the mist and inerting with the inert gas. After extinction oxygen remains at a safe level of 12.5-15% (V). The high-velocity inert gas flow of 35-75 mph velocity in the mixing-injector column formed by an exit in the mixer-injector device entrains the low-velocity mist flowing out of atomizer. The device creates a swirling, high-speed, and expanding flow of the hybrid composition inside the fire protection volume at ambient pressure.

### PRIORITY CLAIM

This application claims benefit of the U.S. provisional patent application Ser. No. 62/613,682 filed on Jan. 4, 2018.

### BACKGROUND OF THE INVENTION

### 1. Field of the Invention

The present invention relates to suppression of fire by a blend of gas like ultrafine water mist and inert gas and more particularly, but not by way of limitation, to an improved method and apparatus for producing and discharging a homogeneous hybrid blend of ultrafine water mist and inert gas.

### 2. Description of the Prior Art

Extended release of clean gas is needed for Class B fires and also some Class A fires to prevent “re-flash” or re-ignition after the extinguishing a fire. The oxygen levels can reach an unsafe level (<12 V %). There is an excessive cost to accomplish this by a clean gas agent. Also, it takes massive amounts of regular water mist to prevent re-flash causing significant water damage and clean-up work and enormous downtime.

There is limited prior art related to the novel aspect of using a water mist and inert gas combination forming a hybrid composition using a method of producing a hybrid blend of mist and inert gas for fire suppression. Experts have tested the application and use of a water mist as a separate agent for total flooding in the past by earlier investigators on various mockups. Applicant's related prior art (U.S. Pat. No. 7,090,028) shows that ultrafine mist can be pulled into (self-entrainment) at the firebase if the velocity of discharge is reasonably slow. The U.S. Navy conducted several investigations on prior art ultrafine mist (U.S. Pat. No. 7,090,028) and found the system impractical for significant size fires. Because of slow momentum, the mist could not penetrate the firebase. The technology was successful for more than a decade. On the other hand, using commercial high-pressure water mist of much greater than 10-micron droplet size resulted in poor mixing due to the difference in discharge timescales for inert gas and water mist. High-pressure mist could not accomplish the performance of the current hybrid blend method and system. Moreover, in high-pressure water mist systems, the water is atomized by an inert gas inline, whereby water concentration cannot be varied independently. Such nitrogen-driven water mist systems and are not hybrid systems creating a hybrid composition at lower pressure. Currently, there is one industrial technology evolving for water mist and nitrogen as hybrid technology. In that system, a review reports on combining multilayer of high-velocity shock waves of nitrogen which atomizes water to below 10 microns. The resulting technology is complex, expensive and has limitations in atomizing water mist. The critical issue is the system cannot provide and test the components independently for synergistic effect since, without nitrogen, the system cannot atomize by shock waves. On the other hand, pressure assisted commercial atomized water mist cannot be entrained easily into nitrogen stream because of larger droplet size and the water and nitrogen molecules do not act on same time scale and the cooling and inerting behavior will not add-up for a synergistic effect. These systems cannot vary the water and nitrogen proportions independently. Applicants are not aware of any fire protection system with a post-mixed hybrid composition of ultrafine water mist and inert gas apart from the present application. Nitrogen acts as a propellant and atomizer but does not attain extinction concentration inside the room.

The present invention (an ultrafine water mist and inert gas hybrid blend method, composition, and device for the system) differs from the prior art commercial method that mixing of inert gas is a post-processing method after the ultrafine mist was produced by the ultrasonic atomization method without using pressure. The inert gas is not an atomizer gas to produce ultrafine mist, unlike in commercial water mist technology described above. The current hybrid blend method works at low release pressures such 200-300 psi as compared to 600-1,000 psi standalone inert gas systems. So, structural integrity test for the room, high-pressure vent control and sound pressure level (SPL) are not of concern in this new system reported here.

So, we need this improved method and hybrid composition and mixer-injector device for independently atomizing water to ultrafine droplets using an inert gas as an aerosolizing agent causing swirled mixing at the mist and nitrogen meeting location at the outlet. The mixing and downstream discharge flow accelerate with an expanding swirl pattern throughout the volume. The extinguishing concentration should be reached as quickly as possible, preferably 60 seconds after reaching the peak concentration. A need exists for a method that also reduces gas turbulence and noise so that electronics and sensitive parts of the protected volume are not adversely affected. A further need exists for post mixing that provides the ability to vary the water mist/inert gas ratio.

### SUMMARY OF THE INVENTION

This invention relates to a method and device for producing a homogeneous blend of gas like ultrafine water mist and an inert gas and discharge it locally to a fire source or flood the volume with a fire source quickly and extinguish the fire. For hybrid composition, one may use not only inert gas but also any of the class of clean gas along with ultrafine water mist. More specifically an ultrafine mist with droplet size 20 microns and preferably below 10 microns with monodisperse size distribution and an inert gas is intimately mixed so that when applied on a fire source locally or volume flooding, the cooling by water and inerting by inert gas takes place simultaneously to extinguish the fire and maintain a safe oxygen level. The method herein uses the inert gas for mixing with ultrafine water mist and not as an atomizer gas for producing ultrafine mist, unlike in commercial water mist technology. This hybrid composition produces a synergistic effect due to the homogeneous mixing of two agents with an enhanced extinguishing behavior. Specifically, a mixer-injector device is disclosed to accomplish the intense mixing, swirling and accelerating the flow. By preparing the mist before mixing, the mist to inert gas ratio can be varied depending on the application. The volume filled with this environmentally friendly, non-wetting agent can prevent, suppress, and extinguish a fire without any collateral damage.

This ultrafine water mist and inert gas hybrid blend method is a product that reduces the cost of system production, installation, and maintenance cost and improves the speed of fire extinguishment. The method can be customized to suit the fire type and room size. The hybrid method is environmentally friendly and non-wetting by minimizing the component agent's requirement and does not demand air-tight structural integrity like clean gaseous system. The cost of refilling nitrogen after each discharge event is about 15×-25× less compared to the clean gas agents. The amount of regular water mist required runs to several gallons/min as compared to a few liters/min of ultrafine water mist, depending on the room size and fire source. Collateral damage due to a large amount of water (regular mist), chemicals, or aerosols for fire prevention and fire protection is cost prohibitive.

An important factor is that the blending of inert gas with a regular water mist (about 100 microns or more) to form a hybrid substance is not efficient. Droplets substantially more than 10 microns diameter size do not behave like a pseudo gas and has different transport time scales compared to an inert gas, preventing efficient mixing and larger droplets that do not vaporize instantaneously causing collateral damage due to wetting. The vaporization rate of below 10-micron size droplet is instantaneous when it reaches the firebase as compared to regular water mist.

The ultrafine water mist and inert gas hybrid blend exhibits a synergistic effect (an enhanced efficiency through the component interaction) of cooling and inerting due to near molecular level blending and mixing process and instantaneous vaporization to enhance cooling and inerting. Both water and inert gas are environmentally friendly. Thus, the ultrafine water mist and inert gas hybrid blend combines the best properties of each agent (water mist and inert gases).

Another important factor that affects the fire extinguishing efficiency is the discharge time to quickly to fill the volume to 95% of extinguishing concentration inside the volume containing fire source. The need for a homogeneous blend of a hybrid mixture of ultrafine droplets and improved dispersion and filling method are critical to next-generation fire protection technology.

The hybrid blend of mist and inert gas has applications in data centers, servers, sub-floor, telecommunications, and hot & cold aisles containment. The hybrid composition is useful as an agent for Class B fires in machinery space and engine rooms and residential and commercial kitchen fires. Other industrial applications involve museums, libraries, archives, and clean rooms, small volume high-value mission critical area applications, local flooding, inerting, and preventing auto ignition and lithium-ion battery explosion mitigation.

### Objectives

An overall objective of this invention is to produce hybrid composition fire extinguishing agent comprising of an intimate blend of ultrafine water mist droplets, of 20 microns or preferably below 10 microns and an inert gas. The mist droplets are entrained into a high-speed inert gas flow through a mixing plane to create a hybrid blend, and the hybrid blend injected with appropriate speed, such as 40 mph or more.

The source of mist can be fixed bed ultrasonic mist reported earlier (U.S. Pat. No. 6,883,724 B2) surface atomization.

The source of ultrafine atomized mist can be microfluidic atomizers, or pressure ultrasonic or pressure atomizer nozzles.

In another objective the mixing of two separate components provides an opportunity to vary the ratios of components for different purposes.

The mist is pre-atomized and is ready to be mixed with a variable proportion of nitrogen mass flow at the exit for generating hybrid flow.

Another important objective is to extinguish the fire within 3-4 min upon the release of hybrid mist agent, preferably below 120 seconds; more preferably 90 seconds.

The hybrid composition of mist and inert gas can extinguish a fire at or above 12.5 v % of oxygen level inside a room.

Another objective is to vary water mist/inert gas ratio according to the fire protection application scenario such as data centers, telecommunications, turbine and engine rooms, data center subfloors and various other applications.

Another objective is to use a mixing plane downstream of the mist flow comprising of an annular swirling inert gas flow surrounding the mist flow and entrain ultrafine droplets at the end of the mist outlet device and generate a homogeneous blend exiting with converging-diverging swirl flow of hybrid mist.

Specific objective is to entrain slow flowing mist by relatively higher velocity inert gas and generate a homogeneous expanding flow of a hybrid mist to fill the fire protection room quickly.

Another objective is to accelerate the downstream flow at the exit with an expanding swirl flow to fill the protected volume quickly and accomplish reaching extinction concentration within 5 minutes.

Another objective is to discharge the swirling flow upwards, downwards or horizontal depending on the fire protection requirement with specified discharge velocity.

Another objective is to reduce the inert gas concentration and to increase the water mist loading to prevent re-flash or re-ignition process because of the enormous cooling power of ultrafine water droplets.

Another objective is to reduce the inert gas requirement using a proportion of ultrafine water mist preventing reduction of the oxygen level to a harmful level.

Another objective is to reduce the inert gas requirement during extended-release for preventing re-flash by stopping the inert gas and either use air for mixing or using only ultrafine water mist to prevent reduction of the oxygen level to a harmful level.

Another objective is to direct the hybrid composition to the fire location by incorporating a fire detection sensor attached to the hybrid blend injector.

Another objective is to have a variable discharge rate in the range 35-55 mph (miles per hour) depending on the fire penetration requirement.

Another objective is to design the mist outlet duct to be flexible and provide variable discharge direction according to the fire location detected.

### BRIEF DESCRIPTION OF THE DRAWINGS

FIG. 1 is a perspective view of a mixer-injector device for an embodiment of the method and device according to a preferred embodiment of the invention.

FIG. 2 is a perspective view of an alternative embodiment of a mixer-injector device according to the invention.

FIG. 3 is a chart illustrating alternative embodiments for the shape of a mist flow director cone according to embodiments of the invention.

FIG. 4 is a top schematic view of a mixer-injector device with an inner flow director cone according to an embodiment of the invention.

FIG. 5 is a top schematic view of a mixer-injector device without an inner cone according to an alternative embodiment of the invention.

FIG. 6 is a front schematic perspective view of a fire protection system and device according to an embodiment of the invention.

FIG. 7 is a front schematic view of an outlay of a fire protection system for a hybrid composition of mist and inert gas with a local agent source (LAS) in a room/enclosure, wherein said cabinet is shown open in the figure but is closed during operation.

FIG. 8a is a front schematic perspective view of a mixer-injector device showing a first horizontal discharge configuration for deploying a hybrid composition in accordance an embodiment of the invention.

FIG. 8b is a front schematic perspective view of a mixer-injector device showing a second upward discharge configuration for deploying a hybrid composition in accordance an embodiment of the invention.

FIG. 8c is a front schematic perspective view of a mixer-injector device showing a third downward discharge configuration for deploying a hybrid composition in accordance an embodiment of the invention.

FIG. 9 is a scatter chart illustrating data using a method of the invention with a Heptane Pool fire test extinguishment results in a 28 m3 room for 200-300 psi release pressure and 8-12% (wt.) water concentration.

FIG. 10 is a line graph plot of time and temperature illustrating data comparing methods of the invention with a Heptane Pool fire test in a 28 m3 room—in particular, the role of water concentration in a water mist/nitrogen hybrid composition agent according to the invention. Curve 1 (no water, only nitrogen); curve 2 (water 9% wt., 200 psi nitrogen release); curve 3 (8% water, 200 psi nitrogen release); curve 4 (12% water, 300 psi nitrogen release).

### DETAILED DESCRIPTION OF THE INVENTION

Referring to the figures, the applicant discloses a hybrid blend process and method using ultrafine water mist and inert gas mixing enhanced by the mixer-injector device design and deployment of a hybrid composition agent. The hybrid composition has a hybrid blend of mist and inert gas. Applicants intend to provide the reader with an enabling understanding of the invention. Applicant does not intend to limit the invention concerning any described features, and the claims define the scope of the invention.

The present invention differs from the prior art commercial methods in that mixing of inert gas is a post-processing method after completion of water atomization. In a first step, water is atomized by an ultrasonic device or other methods to produce ultrafine water mist. Unlike in commercial water mist technologies, in the method described herein the inert gas is not used as an atomizer gas to produce an ultrafine mist or as a propellant. In the present embodiments, the method atomizes the water mist before mixing with an inert gas, which may comprise nitrogen. Mixing of atomized mist with inert gas gives an opportunity to vary the proportions (%) of water and inert gas with a wide range unlike in current nitrogen propellant systems. The inert gas is nitrogen or other inert gases such as CO₂, aragonite, and blends of naturally occurring inert gases including INERGEN™, or PROINERT™. The inert gas may also include other inert gases and clean gas agents such as HFC-227ea, FM-200, FE-227, HFC-125, NOVEC 1230, and other similar clean gaseous agents.

The present embodiment provides an improved hybrid blend of ultrafine water, preferably below 10 microns, and an inert gas for improved cooling and inerting processes. In the method of the embodiment, the hybrid blend acts simultaneously because of a nearly molecular level mixing of both components to produce a pseudo-gas hybrid mist which does not wet or controls for damaging moisture. The method disclosed accomplishes the enhanced mixing via an injector or mixer-injector device. The flow of mist and flow of inert gas pass through this injector and micron-level droplets of the mist are entrained by inert gas at a defined exit area of an injector column. The mixer-injector device mixes the ultrafine mist droplets and the inert gas before they discharge from the injector for deployment into the enclosure with a fire source. The combined flow inside the injector at the exit portion of the injector column is of a helical pattern with expanding swirls. Ultrafine water mist fire suppression without inert gas was disclosed earlier by the present inventors (U.S. Pat. No. 7,090,028). Here, the hybrid composition, method, and mixer injection device of the present improvement improves the fire suppression capability over using only ultrafine water mist.

The ultrafine mist production may derive from any suitable atomization source including: 1) 10 micron or less and monodisperse (uniform droplet size) with various concentrations is produced using high frequency fixed-bed ultrasonic atomizer, 1.4-2.4 MHz (Adiga et al., U.S. Pat. No. 6,883,724), 2) other sources such as surface atomization, 3) microfluidics and 4) ultrasonic pressure or pressure nozzle atomized mist, or others. Further discussion of particular embodiments follows below according to the figures.

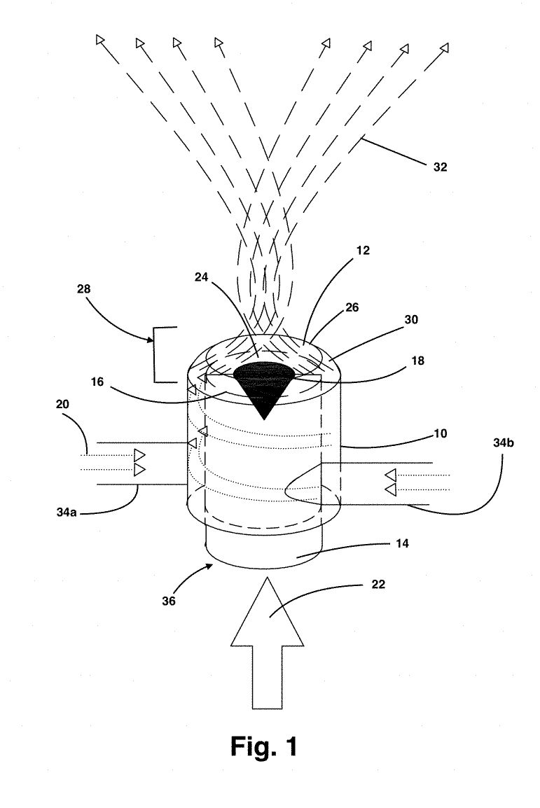

As shown in specific embodiments, the ultrafine water mist is input to a specially developed mixer-injector device as shown in FIG. 1. The figures show the nature of flow inside the injector and mixing pattern. In the embodiment of FIG. 1 the inert gas (nitrogen) enters the body 10 of the injector device tangentially, mixes with the ultrafine mist downstream at an exit portion of the injector column with an intense swirl and exits in an outer annular region 12 for the discharge of the hybrid blend.

The ultrafine mist from any one of the misting sources 82 described in further embodiments flows in the central tube 14. At the end of the mist outlet 16, an inverted solid cone 18 is installed to create an annular out-flow mist rather than a tube-full of flow of the mist. The swirling nitrogen 20 flows in the outer annular region 12 and entrains the mist 22 coming forth from the central tube 14 as the annular flow at the center of the injection column 24 at the exit section 28. The next figures show the shape and length of the top, solid cone 18 and the inner and outer annular flows of the mist 22 and inert gas 20. The swirl flow of inert gas 20 exiting the injector is diverted towards the center of the exit portion 28 of the column by a ring 26 on the end of the injector body 10 having an inward slanting “lip” 30 on the exterior surface of the ring as shown in FIG. 1. The design permits the ring 26 to move backward or forward, (inward and outward on the column of the injector body) so that the exit velocity of inert gas can be varied. In the method, the angle of the inward slanting lip 30 is controlled to manipulate the inert gas flow velocity and entrainment of mist coming through the annular slit formed between the ring 26 and the cone 18.

The inward slanting lip 30 at the exit section 28 end of the injector body is shown clearly in a top perspective view of the injector in FIG. 1. The view shows the annular slits for mist and gas flow. Beginning at the exit section 28 and through discharge, the hybrid blend takes the form of converging and diverging flow 32. As shown in the embodiment, the inert gas is introduced by tangential inlets 34a and 34b from two sides (inlet 1 and 2). In another embodiment, only one inlet may be used by scaling the inert gas mass flow appropriately. The ultrafine mist flow from various sources is introduced at the base inlet 36 of the central tube 14 of the mixing-injector device, as shown. The mist source 22 may comprise an ultrafine mist as generated and transported by a swirling flow of clean gas (See U.S. Ser. No. 06/883,724), ultrasonic atomizer, electrostatic atomizer or any ultrafine droplet atomizers and microfluid atomizer.

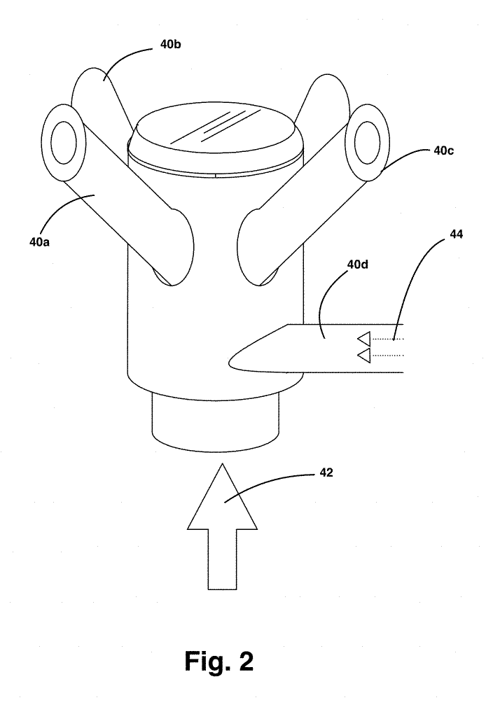

FIG. 2 shows a mixer-injector device for generating hybrid compositions with multiple injectors connected to a single mist source 42. The method introduces nitrogen as an inert gas 44. The modified device discharges the hybrid composition agent with a hybrid blend of mist, and inert gas through four or more discharge nozzles 40a, 40b, 40c and 40d.

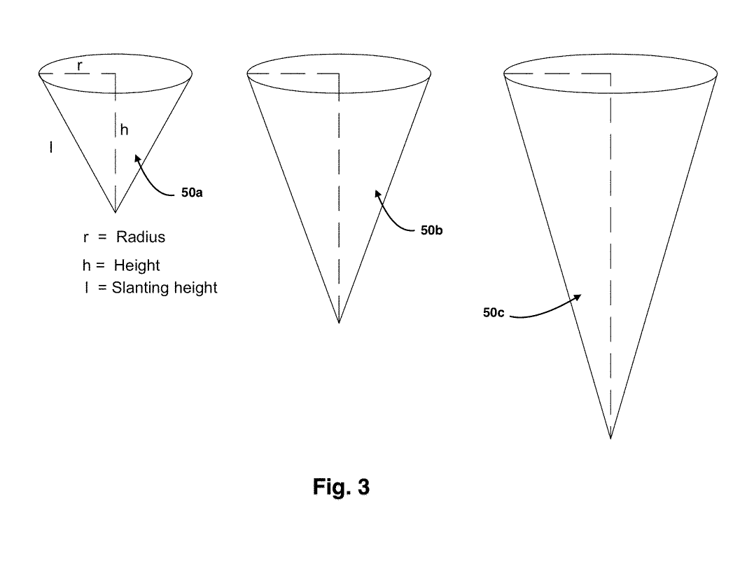

FIG. 3 shows a right-angled cone 50a, 50b, and 50c installed at the exit of the inner mist flow tube 14 as shown in FIG. 1. The height of cone plays its role in rendering a smooth transport of mist transport upwards or through the exit section 28 of the injection column 24 of the mixer-injector device. The geometry of the cone influences the way in which mist smoothly slides upward to the annular slit formed by the cone and the ring. The cone slowly tapers to the apex, preventing the mist from collapsing on the inverted cone. Increasing the height of the cone and the length of the tapered cone surface as illustrated by the transition in size shown by cones 50a, 50b, and 50c controls the loss of mist by preventing the collapse of the mist. The exemplary cone height and length illustrated in the figures is 4-inches. One can vary the cone height and length to control mist transport to the exit section 28 of the injector column 24.

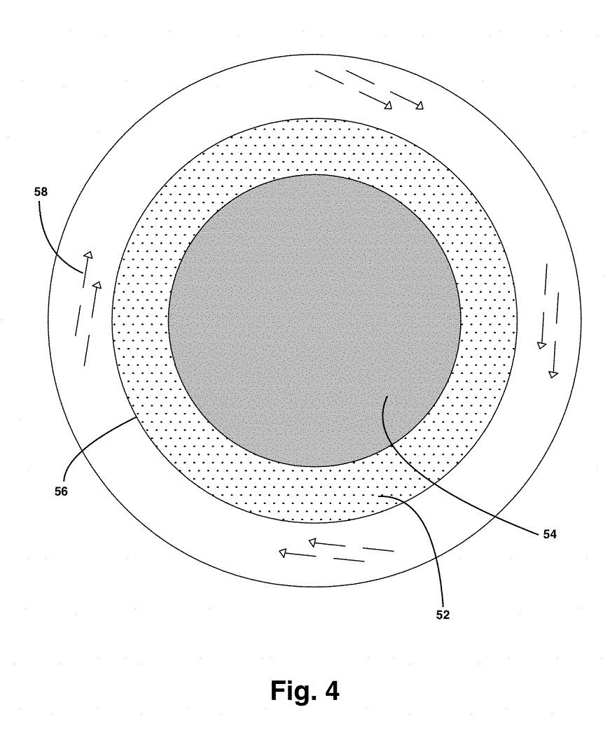

The top view of the annular flow pattern is shown in FIG. 4 where the innermost grey region of the figure shows the mist flow 52 blocked by the inverted cone 54 inserted in the central tube 56, surrounding which is an annular flow of mist and then an outermost flow of inert gas 58. The central circular grey colored section is the top of the inverted cone 54. The cone creates the mist flow through an annular slit of the desired width as formed by the cone and the ring. The inverted cone 54 can be solid or hollow. If the cone is hollow, a hole at the cone may be configured to drop water from inside the central tube 56.

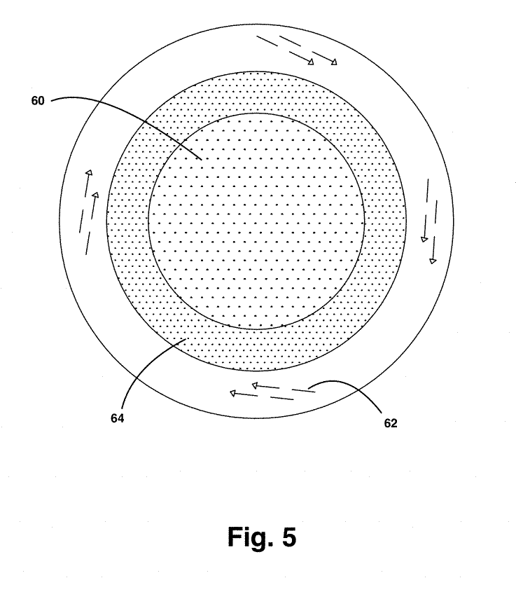

In another embodiment, the system works for acceptable applications without the cone, as a tube-full of flow. The outward flow velocity of mist 60 decreases for these applications. This example is shown in the embodiment of FIG. 5, without the inner cone 18. In this configuration, the mist flow 60 is not directed by the cone into an annular flow. The inner flow is water mist, and outer annular flow is nitrogen 62. In this case, the inner flow diameter and the outer annular flow diameter are varied to generate the required two-phase flow mixing pattern 64 at the exit portion of the injector column and the injector device outlet. Additionally, the inner mist flow can have multiple annular flows to accommodate mist coming from multiple mist sources.

### Example

A method of producing an ultrafine mist for the hybrid blend using a high-frequency submerged atomizer:

This example uses high-frequency water submerged fixed-bed ultrasonic atomizer. Before starting the atomizing apparatus, air is blown on the atomizer to clean the disk surface. A prior patent describes this method (Adiga et al. U.S. Pat. No. 9,533,064). A sensor for the fixed-bed atomizer controls the water level. Also, an over-flow valve can be used to control the water level. The ultrafine mist is then extracted and carried upwards by a carrier gas (air, inert gas, or a mixture). The mist flows through an annular slit created by an inverted cone 18 as shown in FIG. 1, at the end of the mist transport tube 14. Tangential arms 34a and 34b introduce the inert gas via a single arm or multiple arms connected to the mixer-injector.

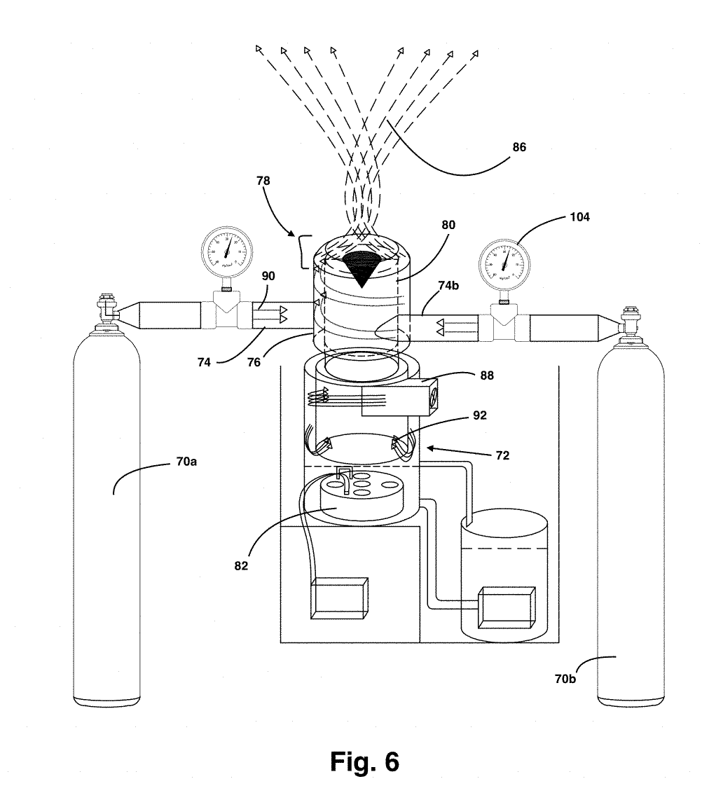

FIG. 6 shows the detailed connections of nitrogen cylinders 70a to the mixer-injector device 72 by two tangential arms 74a and 74b. Used in the local agent source (LAS) model cabinet, these tangential arms 74a and 74b provide inlets for the inert gas. An optional additional filtered air inlet 88 provides a flow of filtered air or nitrogen to assist the mist flow into the central tube of the injector device. The inert gas flows with a swirl flow pattern caused by the tangential inlets and the injector body 76. By substitution, other ways to create the swirl flow of inert gas 90 include using vanes/baffles or other suitable means. The faster moving and swirling inert gas entrains the mist 92 at the exit section 78 of the central transport tube 80 and injector body 84 of the mixing-injector device 72. The hybrid blend flow 86 discharging from the device goes through a converging and diverging flow pattern due to the geometry of the inert gas exiting the injector and entraining the mist. The expanding swirl flow of the hybrid composition discharged fills the room protected from fire. The LAS model cabinet system includes a fire detector and agent release panel 100 installed as shown in the figures.

In another embodiment, the inert gas flow can avoid the inner wall of the injector body in the design so that the inert gas directly swirls and mixes effectively with the center flow of mist. Such a mixing methodology is reported by present inventors (U.S. Pat. No. 7,524,442, 7,744,786) on a drying process introducing tangentially. In this hybrid composition inert gas/mist mixing application, the method can vary the exit velocity of the hybrid blend by converging the discharge end of the tube.

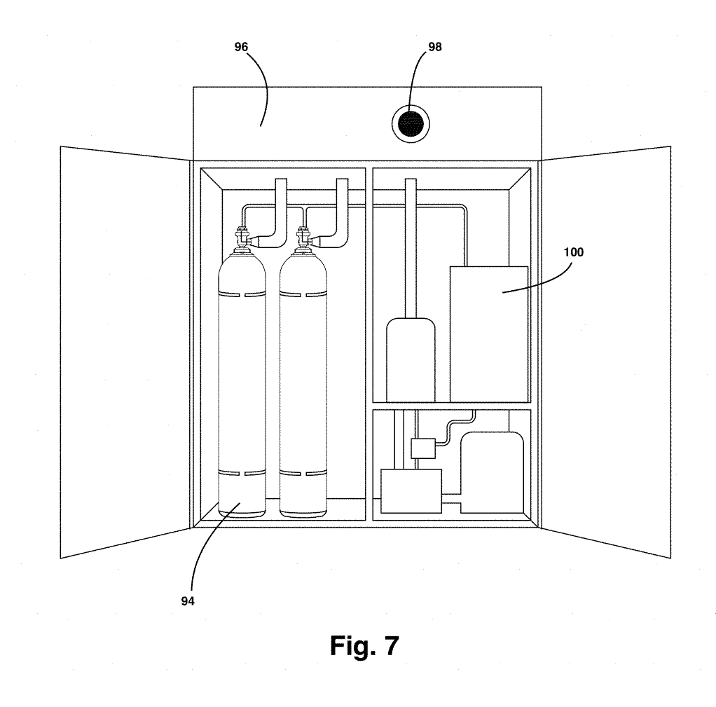

FIG. 7 shows a self-contained nitrogen cylinder system 94 (Local agent source. LAS) and a fire cabinet for the present system. The system provides a unit with appropriate hybrid composition production for a 50 m3 room, a detector system, and a gas release and mister actuator panel. The figure shows the mixer-injector device on the top of the cabinet. The agent discharge velocity is variable depending on the local or total flooding (30-50 mph) applications. This unit is LAS 50 meaning this can protect a 50 m3 enclosure. Enclosure integrity is not needed since the release pressure is relatively low compared to existing high-pressure inert gas systems. Further, the sound-pressure level SPL is low enough, up to 300 PSI release pressure. The nitrogen transport pressure, whether RAS or LAS, is almost ambient because of the construction of mixer-injector design and the new method provided.

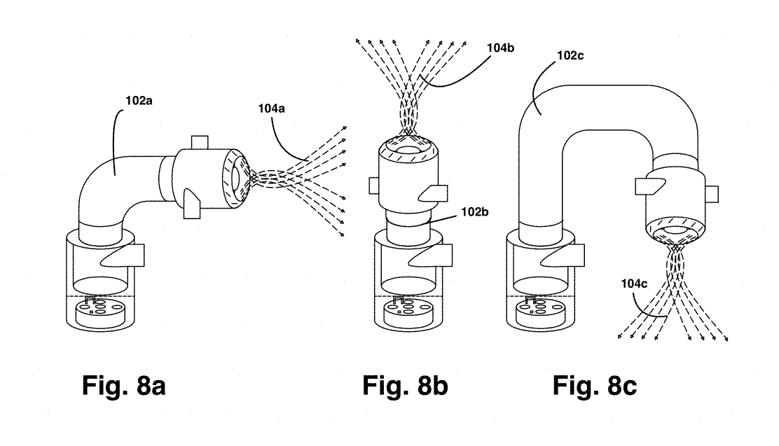

FIGS. 8a, 8b, and 8c show the capability that the hybrid blend can be discharged horizontal, FIG. 8a, upwards, FIG. 8b, or downwards, FIG. 8c, using a suitable flexible elbow 102a, 102b, and 102c depending on the discharge orientation required for the predetermined application. A series of overlapping rings permit manipulation of the elbow angle to change the discharge orientation 104a, 104b, and 104c. Depending on the location and flow angle discharge requirement, the method can control the injector direction mechanically. A fire detector installed on the mixer-injector device can adjust the discharge direction according to the preferred direction determined by the fire detector.

An additional embodiment comprises of a baffle or a plate at the discharge injector end that can direct the flow upward, forward and downward depending on the flow requirement. This mechanical design of flow direction control can link to the detector that finds the fire.

Other embodiments for misting may use surface misting. The surface misting device uses low frequency (40-100 kHz) to produce mist. Water is injected on top of the plate by a metered pump. The mist plume is straight and has momentum like a nozzle mist.

FIG. 7 shows the outlay of an embodiment of the system generating and deploying the hybrid composition inside an enclosure, for example, a data center. More specifically, the room demonstrated in the example is a 28 m3 room (1,000 Cubic feet). The example chose a fire of 1-foot diameter, an n-heptane pool fire, and, this paper describes the outcome below. The experiment placed the mixer-injector device cabinet for the hybrid blend system (with fire-resistant walls) inside the room. The cabinet 96 contains a detector, agent release panel 100, atomizer source 82, mister, a water tank 102, an injector 98, nitrogen cylinder 94. A pressure gauge 104 measures the pressure inside the transport tube from nitrogen to the injector 72. The nitrogen flow inside the transport pipe connecting the nitrogen to the injector is continuously measured. It is found to be near ambient pressure. The cabinet is made up of noncombustible material and must be NFPA approved. Any of the Factory Mutual or UL approved detectors detect the fire. The fire is ignited and set for a pre-burn time of 30 seconds. The detector communicates with the fire panel to release the agent, in this case, a hybrid blend composition of ultrafine water mist and nitrogen, CO2 or any inert gaseous agent. A suitable oxygen sensor or meter measure the oxygen level during extinction with necessary corrections for wet basis and CO2 and other gas interferences. For approval processes, the experiment includes telltales, pool fires, and other NFPA code required fire scenarios. The example tested the embodiment of the invention in a 28 m3 room, for both telltale and pool fires using heptane fuel. The hybrid composition extinguished the fire within 3-4 minutes of initial discharge time at 200 psi release pressure. At 300 psi pressure, the extinction time was reduced, up to 100 seconds. The nitrogen is 49 Liter cylinder (cylinder pressure at 2,400 psi), and the gas is discharged at 200 psi or in selected cases at 300 psi.

The system cabinet for the method and device for the hybrid composition referenced before has two exemplary configurations. Another configuration provides a remote agent source (RAS). This alternative means, the gaseous agent, nitrogen is stored as a bank of cylinders in a remote location and is piped to the cabinet by pipes. As an advantage, the nitrogen cylinder banks are not placed in the data centers locally to the system cabinet.

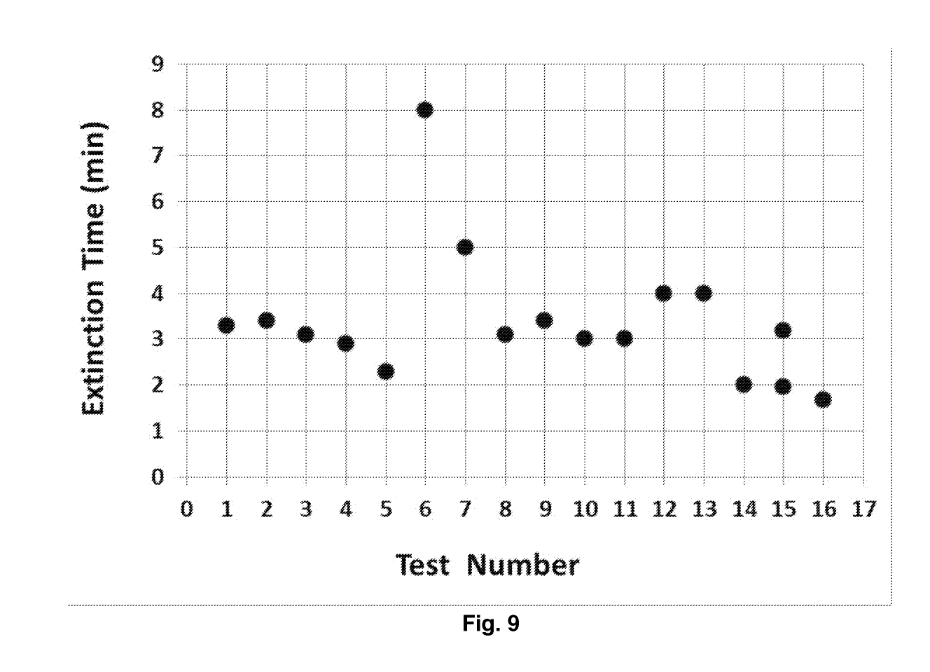

A comprehensive data table is generated on hybrid blend system performance. The water mist rate varied from 300-400 ml/min. The hybrid blend system agent (a hybrid composition of mist and nitrogen) discharge velocity can be varied depending on the room size and fill time, and the number of misting devices required. The design is calculated based on the water/inert gas ratio for specific applications. In one embodiment for 28 m3 room, one mister 400-500 ml/min capacity and about 10-12 kg of nitrogen (inert gas flow) released at 200-300 psi pressure from a 49 L nitrogen cylinder. The water/nitrogen proportions (by mass) varied from 7-12%. The fire extinction time varied from 100 seconds (at 300 psi, 12% water) to 3.5 min (200 psi) depending on water concentration and nitrogen release pressures. The fire was 1-foot diameter n-heptane pool fire, and the test was conducted according to FM 5580 protocol (except for fire size). The extinction time can be as short as 100 seconds depending on water/nitrogen ratio and nitrogen release pressure. FIG. 9 graphically shows the fire extinction results for various tests and repeats. Most of the middle band of data in the graph represents the hybrid composition with pressure release at 200 psi and nominal water of 10% (wt.). The most striking difference is the test of nitrogen only (no water) at 200 psi nitrogen release (test #6). It took about 8 min to put out the fire. It is not a hybrid composition, but only nitrogen. Next, the graph shows a delayed extinction when using an unmixed ultrafine mist, not passing through the injector (test #3, #12, and #13). The test #5 and #6 are at a higher release pressure of 300 psi. In these tests, the hybrid composition extinguished the fire in about 120 seconds or less, close to the time of an inert gas at high-pressure release in other commercial technologies. The shortest extinction occurred at 12% water and 300 psi nitrogen release pressure (Test #16).

The fire extinction at 300 psi at 12% water (Test #16 in FIG. 9) is 100 seconds. This result is below the NFPA 2001 code requirement for inert gases, and no prior art exists reporting such short extinction time in the hybrid blend system at very low release pressure of inert gas.

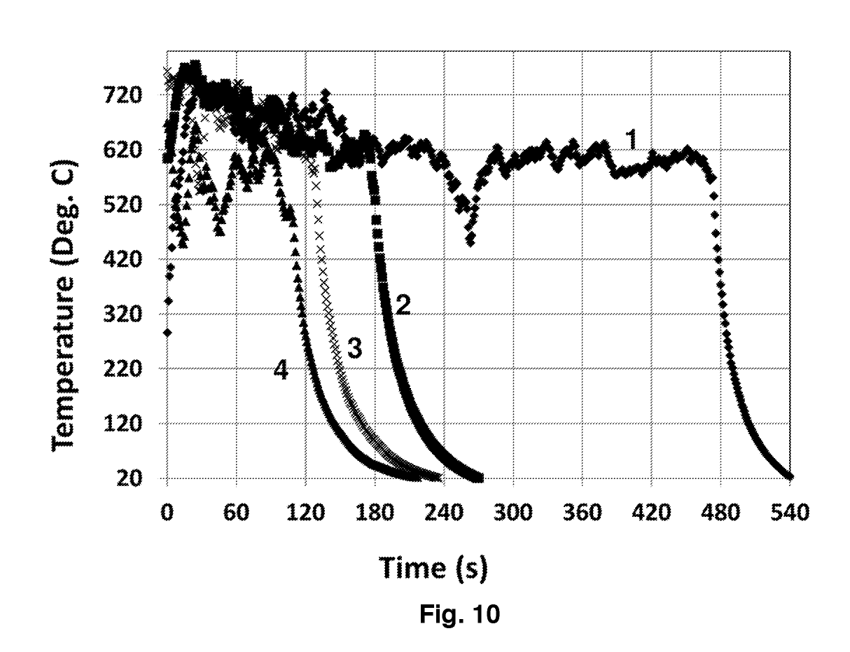

Synergistic effect: FIG. 10 shows an advantageous finding of this invention. While pure nitrogen (without water) in 28 m3 room on n-heptane pool fire takes 8 min to put out the fire at 200 psi nitrogen release pressure, the role of mixing ultrafine mist of about 12% (wt.) through the injector reduces the extinction time to as short as 100 seconds, almost like a high-pressure inert gas. This synergistic effect is a unique feature and illustrates the beneficial role of ultrafine water mist in the hybrid composition of the current invention. A small percentage, 10% of water mist shortened the extinction time from 8 min (pure nitrogen) to about 180 seconds. A single component, nitrogen could not put out the fire in 28 m3 room in a reasonable time (>7 min). The longer time for the single component of nitrogen is not an acceptable fire suppression behavior. Water alone at those flow rates of 400-500 ml cannot put out the fire under similar fire conditions as confirmed by several tests in the past. However, the mixture, as a hybrid composition of these blends could put out a fire as fast as 100 seconds. The reduced extinction time is believed to be a previously unknown synergistic effect caused by the combined effect of a water mist cooling and nitrogen inerting component and the effect of the agent on the fire dynamics (or flow dynamics) and air entrainment at the firebase. There is no prior art of demonstration of the synergistic effect of this hybrid blend system.

Because of low-pressure release (200-300 psi), there is no need for room integrity test, sound pressure level (SPL), or pressure vent control system.

Since static pressure inside the nitrogen transport pipe is either low or near ambient, the system may use CPVC pipes unlike in high-pressure inert gas technologies.

One may use the embodiments described to extinguish fires in many fire scenarios. Some scenarios include data centers (electronics space) and sub-floor, data center hot and cold aisles containment, telecommunication facilities, machinery rooms, museums, libraries, archives, and clean rooms. Additional scenarios include residential and restaurant kitchen fire suppression, medical facilities, and medical equipment, food processing and pharmaceutical lab space, small volume high-value mission-critical areas applications, transformer cooling (selected size and configurations), local flooding, inerting, air blanketing, and preventing auto ignition and lithium-ion battery explosion mitigation.

Specific dimensions and process details relevant to hybrid composition fire protection and fire suppression are provided herein to demonstrate the invention, but these dimensions are not intended to limit the scope of the invention. One skilled in the art may make alterations to the embodiments shown and described herein without departing from the scope of the invention.

We claim:

1. A method of producing a hybrid blend of mist and inert gas for fire suppression comprising steps of:
a. providing a flow of a mist comprising water;
b. providing a flow of inert gas;
c. the flow of inert gas entraining the mist to form the hybrid blend; and
d. discharging the hybrid blend to a fire source.

2. A method of producing the hybrid blend of mist and inert gas for fire suppression as in claim 1 in which the step of said flow of inert gas entraining said water mist to form the hybrid blend forms a homogeneous hybrid blend consisting of water mist and inert gas.

3. A method of producing the hybrid blend of mist and inert gas for fire suppression as in claim 2 in which said inert gas includes any selection of an inert gas blend, a clean gas, or nitrogen.

4. A method of producing the hybrid blend of mist and inert gas for fire suppression as in claim 1 in which said mist comprises water droplets uniformly less than 20-micron diameter.

5. A method of producing the hybrid blend of mist and inert gas for fire suppression as in claim 4 in which the step of providing a flow of mist comprising water includes preparing the mist from a source using a selection of a high-frequency water submerged fixed-bed ultrasonic atomizer, a fixed bed ultrasonic mist surface atomization, a microfluidic atomizer, a pressure ultrasonic atomizer, or a pressure atomizer nozzle.

6. A method of producing the hybrid blend of mist and inert gas for fire suppression as in claim 1 in which said method uses an injector device having an injector body with a tangential inlet, a central tube within said injector body having a mist inlet and mist outlet, and an exit, and
a. said step of providing the flow of mist comprising water includes said flow being through the central tube of injector device;
b. said step of providing the flow of inert gas includes said flow entering the injector body through the tangential inlet creating a swirling flow of inert gas; and
c. said step of said swirling flow of inert gas entraining the water mist to form the hybrid blend occurs downstream of the tangential inlet near the exit of the injector device by the swirling flow of inert gas surrounding the flow of mist.

7. A method of producing the hybrid blend of mist and inert gas for fire suppression as in claim 1 in which said step of the flow of inert gas entraining the water mist to form the hybrid blend includes creating a swirling flow of the inert gas by a tangential inlet to an injector body, by fixed vanes, by baffles, or by other swirling flow generating means, and providing a variable ratio of mist to inert gas determined by controlling a proportion of mass of the swirling flow of inert gas at the exit and by controlling a proportion of the flow of mist.

8. A method of producing the hybrid blend of mist and inert gas for fire suppression as in claim 6 in which the said step of said swirling flow of inert gas entrains the mist to form the hybrid blend includes:
a. providing a mist outlet with an inverted cone causing the flow of mist to move annularly controlled by the geometry of taper of the cone; and
b. providing an outer annular region about the exit where the swirling flow of inert gas entrains the mist through an annular slit formed by the inverted cone and the outer annular region.

9. A method of producing the hybrid blend of mist and inert gas for fire suppression as in claim 8 in which said step of providing the outer annular region about the exit includes providing a ring with an inwardly angled slant determined to control velocity of the swirling flow of inert gas, whereby the combination controls entrainment of the mist through the annular slit.

10. A method of producing the hybrid blend of mist and inert gas for fire suppression as in claim 9 in which said step of said step of providing the ring with an inward and outward movement in relation to the cone to vary annular slit at the exit and control the velocity of the swirling flow of inert gas.

11. A method of producing the hybrid blend of mist and inert gas for fire suppression as in claim 9 in which:
a. the step of providing a ring with the inwardly angled slant determined to control velocity of the swirling flow of inert gas includes providing said swirling flow of inert gas at a high-speed between 35 and 75 miles per hour and diverting the swirling flow of inert gas toward the center of the exit and creating a mixing plane where the entraining the mist to form the hybrid blend occurs; and
b. the step of discharging the hybrid blend to the fire source includes generating an expanding flow of the hybrid blend simultaneously cooling the fire source by mist and inerting the fire source by an inert gas to extinguish the fire source.

12. A method of producing the hybrid blend of mist and inert gas for fire suppression as in claim 6 in which the step of said method using the injector device having the injector body with the tangential inlet includes at least two tangential inlets with each on opposing sides of the injector device, whereby the swirling flow of inert gas includes said flow entering the injector body through the tangential inlets.

13. A method of producing the hybrid blend of mist and inert gas for fire suppression as in claim 11 in which the step of discharging the hybrid blend to the fire source includes deploying the hybrid blend into the fire source at a velocity of 40 miles per hour or greater to fill a protected volume and accomplish an extinction concentration of the hybrid blend.

14. A method of producing the hybrid blend of mist and inert gas for fire suppression as in claim 13 in which the step of deploying the hybrid blend into the fire source at the velocity of 40 miles per hour or greater to fill the protected volume and accomplish the extinction concentration of the hybrid blend includes an additional step of maintaining an oxygen level in the protected volume of greater than 12.5% (V).

15. A method of producing the hybrid blend of mist and inert gas for fire suppression as in claim 1 in which the step of discharging the hybrid blend to the fire source includes:
a. controlling a discharge direction determined by a fire detection sensor or preselected application;
b. controlling a discharge velocity of the hybrid blend according to a preselected application; and
c. deploying the hybrid blend into the fire source to fill a protected volume and accomplish an extinction concentration of the hybrid blend.

16. A method of producing the hybrid blend of mist and inert gas for fire suppression as in claim 15 in which the step of discharging the hybrid blend to the fire source includes forming a converging and diverging flow the hybrid blend.

17. A hybrid composition for fire suppression comprising of a homogeneous blend of:
a. inert gas;
b. clean gas; and
c. a mist of water intimately mixed with the inert gas through entrainment and the mist comprising droplets having a diameter of 20 microns or less.

18. A hybrid composition for fire suppression comprising the homogeneous blend of claim 17 in the mist consists of droplets of said mist have a diameter of 10 microns or less.

19. A mixer-injector device for fire suppression comprising:
a. an atomizing source for generating a mist comprising water droplets less than 20 microns in diameter;
b. an injector body with an outer wall;
c. at least one tangential inlet attached to the outer wall of the injector body for receiving a flow of inert gas;
d. a source of inert gas attached to the at least one tangential inlet for providing the flow of inert gas;
e. a central transport tube within the injector body for receiving a flow of the mist from the atomizing source; and
f. an exit of the injector body including an annular area created by the outer wall of the injector body and the central transport tube where the inert gas entrains the mist.

20. A mixer-injector device for fire suppression as in claim 19 in which:
a. the source of inert gas includes nitrogen cylinders attached to the at least one tangential inlet for providing the flow of inert gas in the form of nitrogen; and
b. the exit of the injector body includes an annular slit created by an inverted cone within an end of the central transport tube at the exit in combination with a ring on an end of the injector body at the exit and the ring having an inwardly angled slant defined by an exterior lip of the ring.
